(19) United States
(12) Patent Application Publication
(10) Pub. No.: US 2005/0113233 A1
(43) Pub. Date: May 26, 2005

(54) Apparatus to fold strip

(75) Inventors: Deni Ferfolja, Bexley (AU); Alfred Alexander Taylor, Lugarno (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TNA Australia Pty Limited, Lidcombe (AU)

(21) Appl. No.: 10/795,082

(22) Filed: Mar. 4, 2004

(30) Foreign Application Priority Data
Mar. 4, 2003 (AU) 2003900986

(51) Int. Cl. B31B 3/00

(52) U.S. Cl. 493/165; 493/7

(57) ABSTRACT

An assembly and method for forming bags (10) having a “block bottom” with external flanges (13). The method and apparatus includes forming folds (18) in a strip (17) and delivering the strip (17) to a former (30) so that the folds (18) engage the forming surface (33) to thereby locate the flanges (18) on the exterior of the tubular bag material (32).

### TECHNICAL FIELD

The present invention relates to packaging machines and more particularly to apparatus that deliver to packaging machines strip material which is formed into bags by the packaging machine.

### BACKGROUND OF THE INVENTION

One form of packaging includes a bag of generally of square or rectangular configuration having flanges at each longitudinal corner. Typically such bags have a “block bottom” so that they stand upright with the flanges extending upwardly.

Machinery that produces the above discussed bags are intermittent in motion. More particularly, the flanges are formed by halting movement of the film and welding the flanges while the film is stationary.

The above discussed apparatus have a number of disadvantages including slow operation as the dwell time for the welding process is time consuming. A further disadvantage is the complexity of the machinery and problems associated with the heaters that form the welds. A still further problem is that frequently the seals in these bags fail as product dropping into the bags ruptures the flanges.

In the above mentioned apparatus it should be noted that the bag material is formed into a tube and then subsequently formed so as to have longitudinally extending flanges. Accordingly, the flanges are formed downstream (after) the bag material has passed the former.

Described in UK Patent Application 2357991 is a bag in which folds are disposed inwardly of the bag to reinforce the bag. A folding apparatus forms folds in the strip bag material, with the folded strip bag material being delivered to a former so that the folds are located internally of the former and do not engage the forming surface of the former. The bags so formed have the disadvantage of reduced area available for printing. A still further disadvantage is that the folds project inwardly of the former and can inhibit the delivery of product to the interior of the tubular bag material. When forming bags with longitudinal flanges, correctly locating the flanges is difficult. This problem is exacerbated when the flanges are inside the bag material. A still further disadvantage is the problem of transversely sealing the bag material. With the folds inside the bag material the sealing jaws engage a layered construction consisting of six layers. Accordingly, the probability of a defective seal being formed is increased. This problem will be exacerbated where stripping is required as product may be difficult to move from the scaled area due to the layered construction.

### OBJECT OF THE INVENTION

It is the object of the present invention to overcome or substantially ameliorate at least one of the above disadvantages.

### SUMMARY OF THE INVENTION

There is disclosed herein an assembly including folding apparatus, through which strip material passes along a predetermined path to be longitudinally folded, and a former to which the strip material is delivered to font the strip material into a tube having longitudinally extending folds, the apparatus including:

a plurality of transversely spaced folding slots extending generally parallel to said path and through which portions of the strip material to be folded are moved;

a press member operatively associated with each slot to press each strip portion into a respective one of the slots to form a fold;

a fold former associated with each slot to engage the folds passing therethrough to deform the folds so that the folds maintain their configuration; and wherein

said former is operatively associated with said folding apparatus so that said folds are on the exterior of said tube.

Preferably, said former has a forming surface over which the strip passes, and wherein said folds contact the former surface

Preferably, each press member is of a circular configuration that rotates as it presses the strip material into the associated slot.

In an alternative preferred form, each press member is a blade that extends into a respective one of the slots to press the strip material into the slot.

Preferably, each fold former is a heated block having a longitudinal slot along which the folds pass to be heated there by.

Preferably, each fold former further includes rollers to engage the folds to secure portions to the folds together so that the folds maintain their configuration.

Preferably, the apparatus forms four generally parallel co-extensive folds.

There is further disclosed herein a combination to form tubular bag material having longitudinally extending flanges, said combination including:

a folding station through which strip bag material passes so as to he longitudinally folded so that the strip material leaving the station has longitudinally extending folds; and

a packaging machine former, operatively associated with the folding station, to receive the bag material with the longitudinally extending folds so that the former provides tubular bag material having longitudinally extending external flanges.

Preferably, said former has a forming surface that engages the strip material to form the tubular bag material, with said folding station being associated with said former so that said folds contact said former surface.

Preferably, the folding station includes a plurality of transversely spaced folding slots extending generally parallel to said path and through which portions of the strip material to be folded are moved; and a press member operatively associated with each slot to press each strip portion into a respective one of the slots to form a fold.

There is further disclosed herein a method of providing tubular bag material having longitudinally extending flanges, said method including the steps of:

providing a supply of strip material to be used to form bags;

moving the strip material from said supply and longitudinally folding the strip material so that the strip material has longitudinally extending folds; and

passing the strip with folds over a packaging machine former so as to provide tubular bag material having external longitudinally extending flanges.

Preferably, the former has a forming surface that contacts the folds.

### BRIEF DESCRIPTION OF THE DRAWINGS

Preferred forms of the present invention will now be described by way of example with reference to the accompanying drawings wherein:

FIG. 1 is a schematic perspective view of a bag formed from flexible strip material;

FIG. 2 is a schematic side elevation of an apparatus to provide film for a packaging machine which forms the bag of FIG. 1;

FIG. 3 is a schematic end elevation of the apparatus of FIG. 2;

FIG. 4 is a schematic side elevation of a modification of the apparatus of FIG. 2;

FIG. 5 is a schematic end elevation of the apparatus of FIG. 4;

FIG. 6 is a schematic top plan view of the apparatus of FIGS. 2 and 3;

FIG. 7 is a schematic end elevation of the strip produced by the apparatus of FIGS. 2 to 6; and

FIG. 8 is a schematic perspective view of a packaging machine former to which the strip of FIG. 7 is being delivered so that the former produces tubular bag material having longitudinally extending flanges.

### DETAILED DESCRIPTION OF THE PREFERRED EMBODIMENTS

In U.S. Pat. Nos. 4,663,917, 3,522,689, 3,070,931, 4,516,379, 3,629,987 and 4,524,567 there are various packaging machines described. These packaging machines have jaws which from discreet bags from tubular bag material. The tubular bag material is formed from strip material delivered to a former 30 (FIG. 8). The strip leaving the former 30 is of a tubular configuration. Typically, the strip is plastics material and is longitudinally scaled and transversely sealed to form discreet bags. Product to be contained in the bags passes through the centre of the former 30 to be delivered to the interior of the tubular bag material.

The strip material delivered to the former 30 comes from a roll.

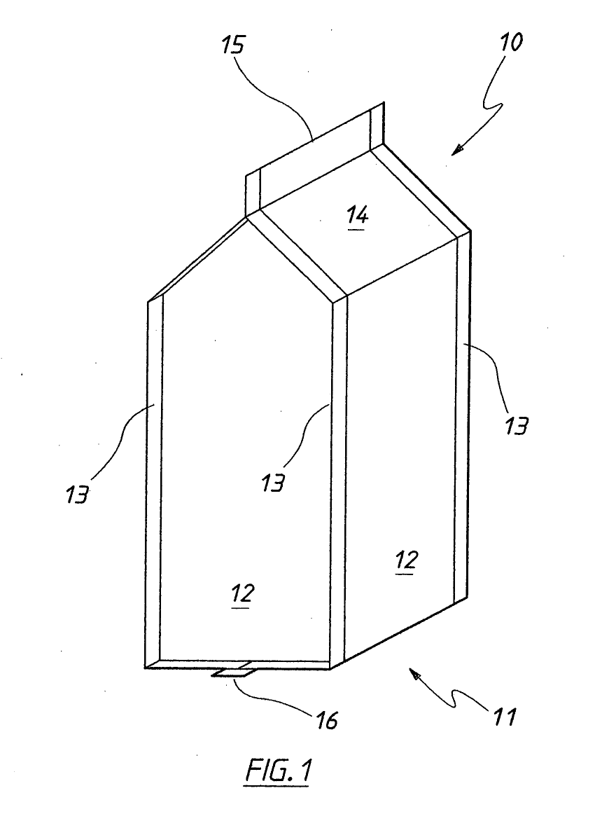

In FIG. 1 there is a schematically depicted a bag 10. The bag 10 has a “block bottom” in that it will stand in a stable manner on its bottom surface 11. The bag 10 has four side panels 12 and may be of a square or rectangular transverse cross-section. Joining the side panels 12 are external flanges 13. The upper end of the bag 10 has sloping portions 14 extending to a top seal 15. The bag 10 also has a bottom seal 16.

The bag 10 is formed from strip material that passes through a packaging machine such as the above mentioned packaging machines.

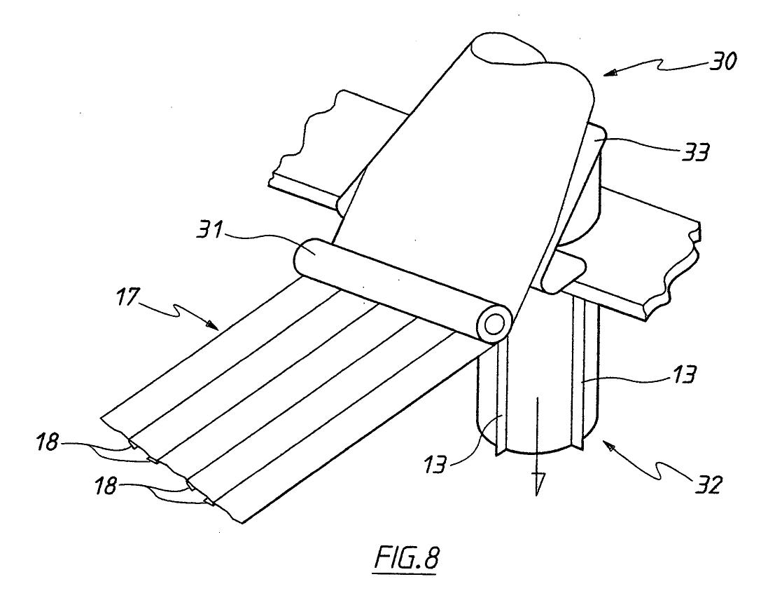

The bag 10 is formed from a strip 17 shown in end elevation in FIG. 7. The strip 17 has longitudinally extending folds 18 that form the external flanges 13 of the bag 10. The strip 17 is preferably formed of plastics material. The folded strip is delivered to a packaging machine former 30 as shown in FIG. 8.

The strip 17 is longitudinally folded at a folding station by means of a folding apparatus 20. The apparatus 20 receives unfolded strip 19 from a roll and forms the longitudinally extending folds 18 so as to provide the strip 17.

The apparatus 20 includes a plurality of elongated members 21 each with a longitudinally extending slot 22. Associated with each slot 22 is a relatively narrow roller 23 that projects inwardly of its associated slot 22.

The strip 19/18 passes along a predetermined path through the apparatus 20. The slots 22 and form folds 18 extend parallel to the longitudinal direction of extension of the strip 17/19 and therefore generally parallel to the path along which the strip 17/19 passes.

As the strip 19 approaches the slots 22 it is deflected into the slots 22 by the rollers 23. More particularly rollers 23 rotate about a generally horizontal axis 24 that extends generally normal to the strip 17/19 and slots 22.

After exiting the slots 22 the strip 17 passes over heating blocks 25. The heating blocks 25 have longitudinally extending slots 26, each slot 26 being aligned with a respective one of the slots 22 so as to receive a respective fold 18. As the strip 17 passes through the blocks 25, the folds 18 are heated to a desired temperature. Upon leaving the heating blocks 25 each fold 18 is engaged by a pair of rollers 27 so that each fold 18 is compressed therebetween so that the plastics material fuses (welds) to thereby ensure that each fold 18 retains its configuration. The rollers 27 rotate about generally vertical axis 28. The axis 28 are generally normal to the strip 17.

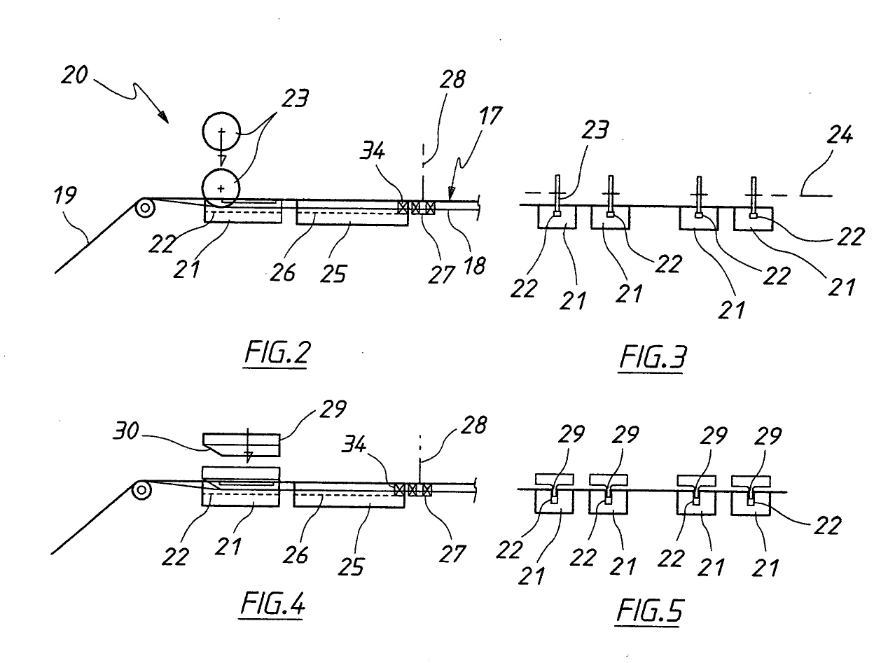

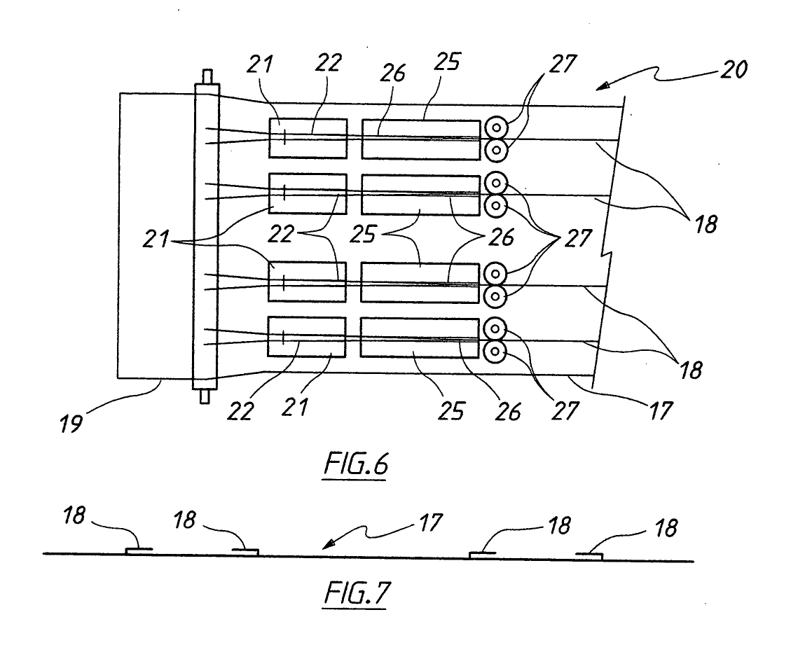

As is best seen in FIGS. 2 and 3, the rollers 23 are movable between a first position at which the rollers 23 are spaced from the slots 22, and a second position projecting inwardly of the slots 22 to form the folds 18.

In this embodiment there are four slots 22 and four associated rollers 23 and four heating blocks 25 each having a slot 26.

In the embodiment of FIGS. 4 and 5 the rollers 23 are replaced by blades 29. The blades 29 are movable in the same manner as the rollers 23 but further includes a ramp surface to aid in moving the strip 19 into the slots 22.

As best seen in the accompanying drawings (particularly FIG. 7) the folds 18 after being formed are subsequently engaged by rollers so that they are applied to a major surface of the strip 17, that is they lay flat on a major surface (bottom) of the strip 17. This facilitates movement of the strip 17 over the former of the packaging machine. The folds 18 are of a “U” shaped configuration in transverse cross-section.

As best seen in FIG. 8, the former 30 receives the strip 17 with the longitudinally extending folds 18. The Strip 17 passes a roller 31 to be delivered to the former 30. The former 30 forms tubular bag material 32 having longitudinally extending external flanges 13. In particular the folds 18 contact the former surface 33 over which the strip 17 passes to be formed into the tubular bag material 32 with the folds 18 on the exterior.

In another embodiment one or more opposing pairs of heated rollers 34 are located in the block 25. The folds 18 pass between the rollers 34 of each opposing pairs 34 to weld the folds 18 so that the folds 18 maintain their configuration.

1. There is disclosed herein an assembly including folding apparatus through which ship material passes along a predetermined path to be longitudinally folded, and a former to which the strip material is delivered to form the strip material into a tube having longitudinally extending folds, the apparatus including:
a plurality of transversely spaced folding slots extending generally parallel to said path and through which portions of the strip material to be folded are moved;
a press member operatively associated with each slot to press each strip portion into a respective one of the slots to form a fold; and wherein
a fold former associated with each slot to engage the folds passing therethrough to deform the folds so that the folds maintain their configuration; and wherein
said former is operatively associated with said folding apparatus so that said folds are on the exterior of said tube.

2. The assembly of claim 1 wherein, said former has a forming surface over which the strip material passes, and wherein said folds contact the forming surface.

3. The assembly of claim 2 wherein, each press member is of a circular configuration that rotates as it presses the strip material into the associated slot.

4. The assembly of claim 3 wherein, each press member is a blade that extends into a respective one of the slots to press the strip material into the slot.

5. The assembly of claim 2 wherein, each fold former is a heated block having a longitudinal slot along which the folds pass to be heated there by.

6. The assembly of claim 2 wherein, each fold former further includes rollers to engage the folds to secure portions to the folds together so that the folds maintain their configuration.

7. The assembly of claim 2 wherein, the apparatus forms four generally parallel coextensive folds.

8. A combination to form tubular bag material having longitudinally extending flanges, said combination including:
a folding station through which strip bag material passes so as to be longitudinally folded so that the strip material leaving the station has longitudinally extending folds; and
a packaging machine former, operatively associated with the folding stations to receive the bag material with the longitudinally extending folds so that the former provides tubular bag material having longitudinally extending external flanges.

9. The combination of claim 8 wherein, said former has a forming surface that engages the strip material to form the tubular bag material, with said folding station being associated with said former so that said folds contact said former surface.

10. The combination of claim 9 wherein, said folding station includes a plurality of transversely spaced folding slots extending generally parallel to said path and through which portions of the strip material to be folded are moved; and a press member operatively associated with each slot to press each strip portion into a respective one of the slots to form a fold.

11. A method of providing tubular bag material having longitudinally extending flanges, said method including the steps of:
providing a supply of strip material to be used to form bags;
moving the strip material from said supply and longitudinally folding the strip material so that the strip material has longitudinally extending folds; and
passing the strip material with folds over a packaging machine former so as to provide tubular bag material having external longitudinally extending flanges.

12. The method of claim 11 wherein, the former has a forming surface that contacts the folds.
